(19) United States
(12) Patent Application Publication
(10) Pub. No.: US 2010/0300066 A1
(43) Pub. Date: Dec. 2, 2010

(54) TURBOJET ENGINE FOR AIRCRAFT

(75) Inventors: Guillaume Bulin, Blagnac (FR); Patrick Oberle, Verdun Sur Garonne (FR)

Correspondence Address: Perman & Green, LLP, 99 Hawley Lane, Stratford, CT, 06614, US

(73) Assignee: AIRBUS OPERATIONS (SOCIETE PAR ACTIONS SIMPLIFIEE), Toulouse (FR)

(21) Appl. No.: 12/665,790

(22) PCT Filed: Jun. 18, 2008
(86) PCT No.: PCT/FR2008/051089

§ 371 Date: Jun. 16, 2010

(30) Foreign Application Priority Data
Jun. 25, 2007 (FR) 0755988

(51) Int. Cl. F02K 99/00

(52) U.S. Cl. 60/267

(57) ABSTRACT

A turbojet engine for an aircraft that includes an engine provided in a nacelle and at least one heat exchanger for cooling down a hot fluid collected in the propulsion system of the turbojet engine before re-injecting the aforementioned partially-cooled hot flow into the aforementioned propulsion system, wherein at least one heat exchanger is a radial heat exchanger extending in the lower portion of the turbojet engine at a lower branching of the turbojet engine.

### CROSS-REFERENCE TO RELATED APPLICATIONS

This application is the National Stage of International Application No. PCT/FR2008/051089 International Filing Date 18 Jun. 2008, which designated the United States of America, and which International Application was published under PCT Article 21 (s) as WO Publication No. WO2009/007564 A2 and which claims priority from, and the benefit of, French Application No. 200755988 filed on 25 Jun. 2007, the disclosures of which are incorporated herein by reference in their entireties.

The aspects of the disclosed embodiments relate to a turbojet engine for an aircraft. More precisely, the aspects of the disclosed embodiments relate to a heat exchanger, also called a surface exchanger, housed in a turbojet engine. The heat exchanger pursuant to the aspects of the disclosed embodiments is intended to cool a hot fluid of the propulsive system of the turbojet engine, such as oil, so that it can be reinjected into said propulsive system at least partly cooled. The aspects of the disclosed embodiments also relate to an aircraft that has at least one such turbojet engine.

Generally, the heat exchanger pursuant to the aspects of the disclosed embodiments finds applications when it is necessary to cool a fluid circulating in or on the periphery of a turbojet engine.

### BACKGROUND

In the field of civil aviation, it is known how to use a supplementary heat exchanger to cool the oil that circulates in the motor of the turbojet engine. The hot oil is fed into the heat exchanger, where it is cooled before being reinjected into the propulsive system.

In the prior art, two positions exist in general for the heat exchanger, namely on the engine or on the nacelle.

However, if the heat exchanger is mounted in the nacelle with an air discharge to the outside, the removal of air constitutes a direct loss of propulsive yield to the extent that it contributes little or nothing to the thrust of the engine. If the heat exchanger is mounted in the body of the engine, the nozzle of the heat exchanger by its internal architecture causes a large loss of pressure in the flow and tends to perturb more or less significantly the aerodynamic flow downstream from the engine.

Another known method is to use a plate exchanger matching locally the form of the internal wall of the nacelle to which it is joined. An upper face of the heat exchanger is joined to the internal wall of the nacelle, while a lower face is located in the stream of cold air that passes through the internal volume of the nacelle. The heat transported to the body of the exchanger is transferred by thermal conduction to the internal surface of the plate that forms the lower face of said heat exchanger. This hot plate is washed by the stream of cold air flowing in the nacelle. The heat stored in the hot plate is thus dissipated by forced convection toward the aerodynamic flow of the turbojet engine.

It is a drawback to this second embodiment of a heat exchanger according to the prior art that it reduces the surfaces available for the actual systems for reducing loud noise nuisances from the turbojet engine. Actually to reduce these loud noises, it is known how to cover the internal wall of the nacelle at least partially with an acoustic liner. More generally, this acoustic liner covers the internal and external walls of the nacelle and of the engine cowling when these two walls face one another. The presence of this acoustic liner is incompatible with the joining of the heat exchanger to plates on the internal wall of the nacelle. To use such a plate heat exchanger, it would be necessary to omit the acoustic liner locally, which proves to be difficult in view of the dimensional criteria relative to the loud noises.

### SUMMARY

In the disclosed embodiments, it is desired to furnish a heat exchanger capable of cooling a fluid, such as oil or other heat transfer fluid, originating from the propulsive system of the engine, which can be installed easily in a turbojet engine and can be adapted to the current standards and constraints, especially acoustic. It is also desired to furnish a heat exchanger that has a greater output than the output of the heat exchangers of the prior art, in other words greater cooling capacity.

To do this in the disclosed embodiments, it is proposed to place one or more heat exchangers at the lower bifurcation of the turbojet engine. The lower bifurcation traditionally extends in the bottom part of the turbojet engine, between the external wall of the engine and the internal wall of the nacelle. The bottom part of the turbojet engine means the part intended to face the ground when the turbojet engine is mounted on the bottom face of a wing of the aircraft. The lower bifurcation is positioned downstream from the turboblower and the vanes of the fan straightener. Since it does not directly face an internal wall of the nacelle or an external wall of the engine cowling, the lower bifurcation is not generally covered by an acoustic treatment. Thus in accordance with the disclosed embodiments, one or more surface heat exchangers are integrated at the lower bifurcation so as to dissipate the thermal emission in the internal flow of the engine, while limiting the aerodynamic drag caused and without influencing the acoustic treatment of the nacelle. The lower bifurcation most often extends to the neck of the nacelle and for this reason is relatively cumbersome, to be able to house conduits, electrical cables, the drive shaft from the gearbox to accessories, etc., that have to pass from the engine to equipment contained in the body of the nacelle, and vice versa. In some turbojet engines, part of the equipment is combined in the engine itself, which eliminates some of the conduits and cables. Then the internal volume of the lower bifurcation and its general bulk can be reduced. If the lower bifurcation is reduced, the heat exchanger(s) pursuant to the disclosed embodiments can advantageously be arranged in the extension of said lower bifurcation. Otherwise, the heat exchanger(s) can extend on both sides of the bifurcation, parallel to said bifurcation. In some cases it is possible to join an external wall of a heat exchanger to the external wall of the bifurcation so as to reduce the bulk of the assembly. However, in this case only one heat exchange surface exists per heat exchanger.

Accordingly, the subject matter of the disclosed embodiments is a turbojet engine for an aircraft that has an engine housed in a nacelle and at least one heat exchanger intended to cool a hot fluid removed from the propulsive system of the turbojet engine before reinjection of said partially cooled hot fluid into said propulsive system, characterized in that at least one heat exchanger is a radial heat exchanger extending in the bottom part of the turbojet engine at a lower bifurcation of the turbojet engine.

By radial is meant that it is perpendicular to the longitudinal axis of the turbojet engine. In other words, the heat exchanger pursuant to the disclosed embodiments extends from the engine to the internal wall of the nacelle and partially traverses the internal volume of said nacelle.

According to examples of embodiment of the turbojet engine pursuant to the disclosed embodiments, it is possible to provide that at least one radial heat exchanger extends along a side wall of the lower bifurcation.

The radial heat exchanger extends parallel to a flank, or side wall, of the bifurcation, without necessarily being joined to said side wall.

If the radial heat exchanger is joined, the aerodynamic perturbations caused by the presence of the radial heat exchanger are reduced. For example, an external wall of the radial heat exchanger is integral with an external wall of the lower bifurcation. External wall means the wall facing the internal volume of the nacelle and the air passage channel in which they are housed. Internal accordingly means pointed toward the lower bifurcation.

Conversely, if the radial heat exchanger is arranged at a distance from the bifurcation, the exchange surfaces are increased and with it the cooling efficacy of said radial heat exchanger. The radial heat exchanger preferably then extends downstream from the lower bifurcation in its aerodynamic extension.

A particular example of embodiment of the turbojet engine pursuant to the disclosed embodiments provides that at least one radial heat exchanger is integral with the engine

With the exchanger then being integrated and close to the jet engine, maintenance operations on the equipment are simplified. This can avoid having to disconnect the fluid connections between the engine and the exchanger, for example, which would be the case for propulsion assemblies in which the exchanger is not fastened directly to the engine.

### BRIEF DESCRIPTION OF THE DRAWINGS

The disclosed embodiments will be better understood by reading the following description and examining the figures that accompany it. These are shown by way of example and do not limit the disclosed embodiments in any way. The figures show:

FIG. 1. A longitudinal cross-sectional view of a turbojet engine that can be equipped with at least one radial heat exchanger pursuant to the disclosed embodiments;

FIG. 2. A cross-sectional view along the line B-B of a first example of embodiment of heat exchangers pursuant to the disclosed embodiments;

FIG. 3. A cross-sectional view along the line B-B of a second example of embodiment of heat exchangers pursuant to the disclosed embodiments;

FIG. 4. A cross-sectional view along the line B-B of a third example of embodiment of heat exchangers pursuant to the disclosed embodiments.

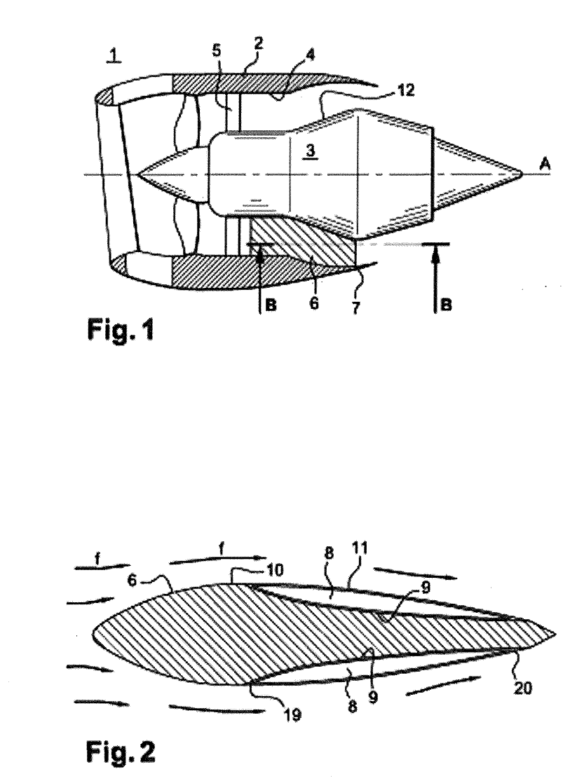

FIG. 1 shows a turbojet engine 1 in longitudinal cross section along the longitudinal axis A of said turbojet engine 1.

### DETAILED DESCRIPTION

The turbojet engine 1 traditionally has a nacelle 2 in which an engine 3 is housed. The engine 3 is fastened to an internal wall 4 of the nacelle 2 in part through vanes 5 of the fan straightener. The turbojet engine 1 is equipped with a lower bifurcation 6 that can extend in length from the vanes 5 to the rear extremity 7 of the nacelle 2. Length means the dimension extending parallel to the axis A. Front and rear mean relative to the direction of motion in normal operation of an aircraft equipped with such a turbojet engine 1. The lower bifurcation 6 extends in height from the external wall 12 of the engine 3 to the internal wall 4 of the nacelle 2. Height means the dimension extending radially from the longitudinal axis A.

The heat exchanger(s) pursuant to the disclosed embodiments is/are situated in the environment of this lower bifurcation 6, in other words along the side walls of said bifurcation 6, downstream from said bifurcation 6, etc.

FIGS. 2, 3, and 4 show three non-limiting examples of embodiment of heat exchangers pursuant to the disclosed embodiments.

The lower bifurcation 6 of FIG. 2 extends in length from the rear of the vanes 5 to the rear extremity 7 of the nacelle 2. The lower bifurcation 6 of FIG. 2 accordingly has maximum bulk. Two vertical heat exchangers 8 pursuant to the disclosed embodiments are on both flanks of the lower bifurcation 6. Said vertical heat exchangers 8 extend parallel to the lower bifurcation 6, from the external wall 12 of the engine 3 to the external wall 4 of the nacelle 2. The heat exchangers 8 are advantageously integral at their top extremity with the external wall of the engine.

So as not to increase the bulk of the installations in the air passage channel, each radial heat exchanger 8 has an internal side wall 9 joined to an external side wall 10 of the lower bifurcation 6. More precisely, the lower bifurcation 6 is hollowed so that a general external contour of the lower bifurcation assembly 6 and heat exchangers 8 corresponds to the general external contour of a lower bifurcation 6 of the prior art lacking a heat exchanger. Only the external wall 11 of the vertical heat exchangers 8 is washed by the flow of cold air f passing through the air passage channel in which the lower bifurcation 6 and the vertical heat exchangers 8 are lodged.

Of course the heat exchangers 8 could also be slightly shifted away from the external wall 10 of the lower bifurcation 6. Thus, air passing through the air passage channel could pass between the internal wall 9 of the heat exchangers 8 and the external wall 10 of the lower bifurcation 6. The heat exchangers 8 would then have two heat exchange surfaces 9, 11.

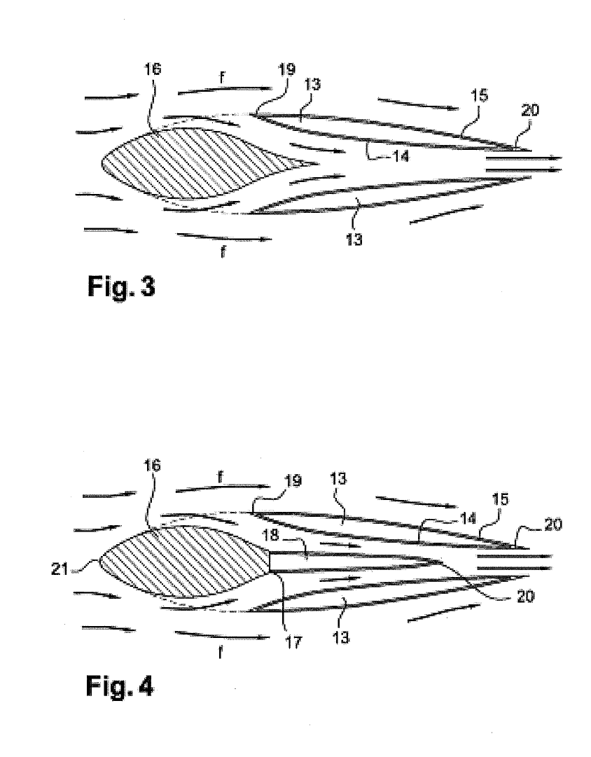

In FIGS. 3 and 4 the lower bifurcation is reduced in such a way that it is less bulky than in FIG. 2. Actually, the reduced lower bifurcation 16 does not extend in length to the rear extremity of the nacelle.

In a particular example of embodiment of the reduced bifurcation, it is possible to provide regulating systems such as leaf valves or air inlets with variable geometry to control the flow rate of air passing over said bifurcation 16.

The reduced bifurcation 16 of FIG. 3 is flanked by two lateral vertical heat exchangers 13 arranged on both sides and downstream from the reduced bifurcation 16. So as not to disturb the flow of the air in the air passage channel, the lateral vertical heat exchangers 13 follow an aerodynamic profile of the bifurcation 16. Each lateral heat exchanger 13 has two heat exchanges surfaces, at the internal wall 14 and the external wall 15, respectively.

In the example shown in FIG. 4, besides the two lateral vertical heat exchangers 13, the turbojet engine 1 is equipped with a central radial heat exchanger 18 extending in the rear extension of the reduced bifurcation 16. More precisely, a rear extremity 17 of the bifurcation 16 is extended by a central heat exchanger 18.

The three heat exchangers 13, 18 of FIG. 4 are equipped with two heat exchange surfaces. The bottom part of the secondary flow f entrained by the turboblower traverses the plane of the straighteners 5, passes around the reduced bifurcation 16, and flows tangentially to the internal and external faces of each heat exchanger 13, 18. The transfer of heat energy is then produced by forced convection between the hot walls of the heat exchangers 13, 18 and the flow of fresh air f.

Generally, the vertical heat exchangers 8, 13, 18 pursuant to the disclosed embodiments advantageously have a general profiled shape that has a leading edge 19, two side walls 9, 11, 14, 15, and a trailing edge 20. In the case of the central radial heat exchanger 18, the leading edge corresponds to the leading edge 21 of the bifurcation 16.

Of course other types of positioning of the heat exchangers 8, 13, 18 can be envisaged so as more or less to increase the exchange surface and to more or less limit the bulk and the aerodynamic impact on the internal flow of the turbojet engine 1.

Of course the vertical heat exchangers 8, 13, 18 can have smooth heat exchange surfaces or can be provided with protuberances that can increase efficacy, such as fins, spoilers, corrugations, etc.

In the same way, it is conceivable to integrate vertical heat exchangers 8, 13, 18 downstream from the lower bifurcation 6, 16 that are equipped with a perfectly smooth surface on their external wall so as to limit the turbulence in the aerodynamic flow of the turbojet engine 1 at the periphery of the bifurcation 6, 16, and equipped with fins and protuberances between the internal walls, increasing the efficacy of exchange within the aerodynamic flow appearing between the heat exchangers 8, 13, 18.

The heat exchangers pursuant to the disclosed embodiments being of the surface exchanger type, and being arranged in the extension of the lower bifurcation, they generate only a limited level of aerodynamic perturbations capable of impacting the performance of the propulsion assembly. The heat exchangers pursuant to the disclosed embodiments have no curved and complicated channel that can cause internal and external perturbations at the heat exchanger.

In addition, the heat exchangers pursuant to the disclosed embodiments do not impact the parietal acoustic treatment of the nacelle if they are integrated in the areas traditionally not equipped with acoustic treatment. It is thus possible to use heat exchangers in a propulsion assembly without detriment to the acoustic treatment.

In other respects, the heat exchangers pursuant to the disclosed embodiments contribute to increasing the output of the propulsion assembly, reinjecting the thermal emissions of the engine and of its accessories into the aerodynamic flow of the turbojet engine. Thus this heat energy is not lost by being ejected to the exterior of the nacelle or by being dissipated by loss of pressure at the nozzle of the exchanger.

In parallel, it should be pointed out that the positioning of the heat exchangers at the lower bifurcation tends to simplify their accessibility and maintenance.

1. Turbojet engine for an aircraft that has an engine housed in a nacelle and at least one heat exchanger intended to cool a hot fluid removed from the propulsive system of the turbojet engine before reinjection of said partially cooled hot fluid into said propulsive system, wherein at least one surface heat exchanger is a radial heat exchanger extending in the bottom part of the turbojet engine at a lower bifurcation of the turbojet engine arranged downstream from the turboblower and the vanes of the fan straightener of said turbojet engine, with the heat exchanger extending parallel to an external side wall of the lower bifurcation.

2. Turbojet engine according to claim 1, wherein the radial heat exchanger extends along a side wall of the lower bifurcation.

3. Turbojet engine according to claim 2, wherein an internal wall of the radial heat exchanger is integral with an external side wall of the lower bifurcation.

4. Turbojet engine according to claim 1, wherein the radial heat exchanger extends downstream from the lower reduced bifurcation.

5. Turbojet engine according to claim 1, in which the radial heat exchanger is integral with the engine.
